(19) United States
(12) Patent Application Publication
(10) Pub. No.: US 2004/0093403 A1
(43) Pub. Date: May 13, 2004

(54) Communication quality management system, communication quality management method, program, and recording medium

(76) Inventors: Toru Toyama, Tokyo (JP); Akio Zama, Tokyo (JP)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/468,774

(22) PCT Filed: Feb. 7, 2002
(86) PCT No.: PCT/JP02/01009

(30) Foreign Application Priority Data
Feb. 22, 2001 (JP) 2001-046099

(51) Int. Cl. G06F 15/173

(52) U.S. Cl. 709/223

(57) ABSTRACT

A system for uniformly controlling and guaranteeing the quality of communication between a first communication apparatus present in a first ISP network and second communication apparatus present in a second ISP network above a predetermined level. At least part of the communication quality data on the communication path between first and second communication apparatus (2, 6) is measured by means of a first measurement apparatus (3) installed in a first ISP network (1A). At least part of the communication quality data on the communication path is measured by means of a second measurement apparatus (5) installed in a second network (1B). The data measured by the first measurement apparatus (3) and the data measured by the second measurement apparatus (5) are collected and controlled by a control apparatus (7).

### TECHNICAL FIELD

The present invention relates to a control system and a control method for comprehensively controlling communication quality between multiple ISP networks where multiple communication apparatuses communicate through the multiple ISP networks.

### BACKGROUND ART

Referring to FIGS. 9(a) and (b), and FIG. 10, the following section describes a conventional method of how to control quality data of inter-network communication. For example, as shown in FIG. 9(a), it is assumed that communication between a communication apparatus 2 in an ISP network 1A and a communication apparatus 6 in an ISP network 1B routes through an intermediate ISP network 11. Interface apparatuses (such as routers) disposed at the ends of the individual networks are indicated as 12A through 12D. With this constitution, to maintain the communication quality, independent facilities are used for controlling the quality according to unique criterion respectively in the individual ISP networks. Namely, as shown in FIG. 9(b), a communication quality measuring apparatus 13, a computer for control 14, and a display apparatus 15 are provided in the network 1A. Then, first, the communication quality measuring apparatus 13 measures communication quality data between the communication quality measuring apparatus 13 and the communication apparatus 2 (S21 in FIG. 10). As the communication quality data, presently, a packet round trip time is generally used. The packet round trip time is an actual time required for a packet to make a round trip in the ISP network 1A. In other words, the packet round trip time is a period in which after the apparatus 13 sends out a packet data, the packet data reaches the communication apparatus 2, and then, is sent back to the apparatus 13. The shorter the packet round trip time becomes, the higher the communication quality becomes.

Then, the communication quality data obtained by the measurement is transmitted to the control apparatus 14 as an arrow 16 indicates. The control apparatus 14 examines an existence of a missing communication quality data (S22). If a data is not transmitted to the control apparatus 14 due to a failure of obtaining the data in S21, since the data is not present, information for instructing display of an alarm is transmitted to the display apparatus 15 as an arrow 17 indicates, and the alarm is shown on the display apparatus 15 (S23). If the communication quality data is present in S22, it is examined whether the data satisfies a criterion (S24). If the data does not meet the criterion, information for instructing display of an alarm is transmitted to the display apparatus 15 as the arrow 17 indicates, and the alarm is shown on the display apparatus 15 (S25). If the data meets the criterion, the processing terminates, and the procedure returns to START. Similar processing is also conducted in the ISP network 1B.

### DISCLOSURE OF THE INVENTION

Conventionally, as described above, though the communication control inside an individual ISP network has been studied, communication control technology for connecting and operating multiple ISP networks has been overlooked. As a result, with the prior art, it is impossible to run a business which always guarantees a user for a certain level of quality of communication between multiple ISP networks.

This is because that, in the example in FIG. 9, the packet round trip time around the communication quality measuring apparatus 13 in the network 1A can be measured and controlled in the network 1A, and the packet round trip time around the communication quality measuring apparatus can be measured and controlled similarly in the network 1B. However, with the control described above, the communication quality between the communication apparatus 2 in the network 1A and the communication apparatus 6 in the network 1B cannot be controlled, and it is impossible to guarantee a certain level of the communication quality. First of all, in the prior art, the necessity of directly controlling the communication quality data between the communication apparatus in the network 1A and the communication apparatus in the network 1B is not recognized, and consequently, the communication quality only inside the networks is controlled. As a result, a controlling person in the network 1A is independent to a controlling person in the network 1B. In addition, specifications of the communication quality measuring apparatus in the network 1A, and specifications of the communication quality measuring apparatus in the network 1B are not unified, and are usually different from each other. Additionally, the quality criterion for releasing the alarm (S25 in FIG. 10) in the network 1A and the quality criterion for releasing the alarm in the network 1B are different from each other. In this state, it is considered that the communication quality between multiple networks decreases to a level of the communication quality in a network controlled with the lowest quality criterion at the moment.

The object of the present invention is to provide a system which controls and guarantees the quality of the communication between a first communication apparatus in a first ISP network and a second communication apparatus in a second ISP network always above a certain level.

According to the present invention, a communication quality control system for controlling quality of communication between a first communication apparatus existing in a first ISP network and a second communication apparatus existing in a second ISP network includes: a control unit for collecting and controlling communication quality data measured by a first communication quality measuring apparatus in the first ISP network for at least a part of a communication path between the first communication apparatus and the second communication apparatus, and communication quality data measured by a second communication quality measuring apparatus in the second ISP network for at least a part of the communication path.

Furthermore, the present invention is a communication quality control method by using the communication quality control system

The present invention is a program of instructions for execution by the computer to perform a communication quality control process for controlling quality of communication between a first communication apparatus existing in a first ISP network and a second communication apparatus existing in a second ISP network; the process including: a collecting step for collecting into a control unit communication quality data measured by a first communication quality measuring apparatus in the first ISP network for at least a part of a communication path between the first communication apparatus and the second communication apparatus, and communication quality data measured by a second communication quality measuring apparatus in the second ISP network for at least a part of the communication path. Furthermore, the present invention is a computer-readable medium having the program.

The present inventor came up with such an idea that the first measuring apparatus provided in the first ISP network obtains the communication quality data, simultaneously the second measuring apparatus provided in the second ISP network obtains the communication quality data, control means collects the communication quality data measured by the first measuring apparatus, and the communication quality data measured by the second measuring apparatus for unified control. As a result, the quality of the communication between the first communication apparatus existing in the first ISP network and the second communication apparatus existing in the second ISP network is controlled and guaranteed in a unified way above a certain level.

### BRIEF DESCRIPTION OF THE DRAWINGS

FIG. 1 is a block diagram schematically showing the constitution of a system according to an embodiment of the present invention;

FIG. 2 is a chart showing relationships between individual communication apparatuses and individual communication quality measuring apparatuses in FIG. 1, and individual communication quality data;

FIG. 3 is a block diagram schematically showing the constitution of a system according to another embodiment of the present invention where an apparatus in a network 1A and an apparatus in a network 1B communicate with each other through an intermediate ISP network 11;

FIG. 4 is a chart showing relationships between individual communication apparatuses and individual communication quality measuring apparatuses in FIG. 3, and individual communication quality data;

FIG. 5 is a block diagram schematically showing the constitutions of a control apparatus 7 and an output apparatus 10;

FIG. 6 is a typical flowchart when the present invention is applied;

FIG. 7 is a flowchart showing a flow of processing in a first routine;

FIG. 8 is a flow chart showing a flow of processing in a second routine;

FIG. 9 is a block diagram schematically showing the constitution of a prior art system; and

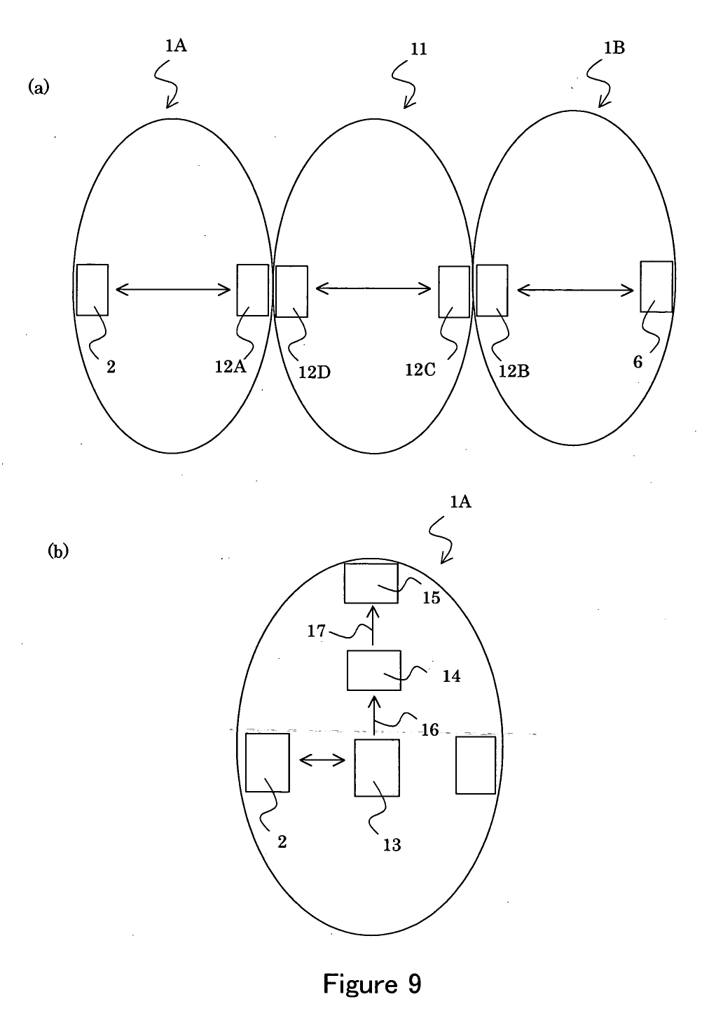

FIG. 10 is a flowchart showing a flow of processing in the conventional system.

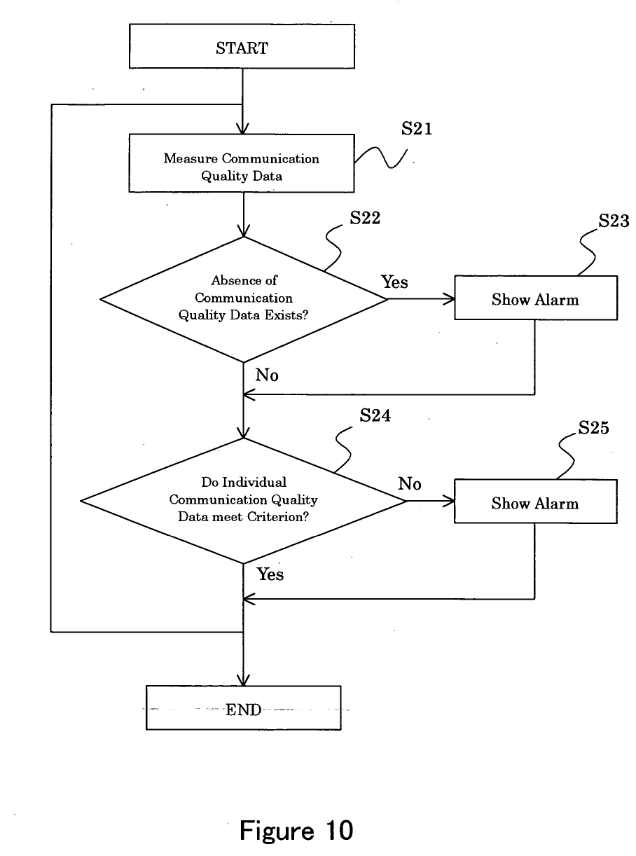

### BEST MODE FOR CARRYING OUT THE INVENTION

In the present invention, the type and the number of individual communication apparatuses are not limited. The types and specifications of the communication apparatus in a first ISP network and those of the communication apparatus in a second ISP network may be identical or different. In addition, means for transmitting individual communication quality data to control means is not limited.

A specific control method for controlling the communication quality data in the control means is not limited. Basically, controlling the communication quality data implies informing a controlling person of a deviation of the data from a normal range in one method or another. For example, as described later, it is possible to confirm an existence of a missing individual communication quality data, and to instruct a release of an alarm if the individual communication quality data do not meet criterion when they are compared with the criterion.

Though the types of the communication quality data are not limited as long as they indicate the communication quality, the following types are general.

1. Packet round trip time: Time actually required for a round trip of a packet data between the communication quality measuring apparatus and a target apparatus

2. Delay measured utilizing time-synchronizing feature: Delay of a packet data measured with time-synchronizing feature of network in an ISP network

3. File transfer time: Time required for actually transferring a file between a communication quality measuring apparatus and a target apparatus

4. One way trip time: Time actually required for a one way trip (one direction trip) of a packet data from a communication quality measuring apparatus to a target apparatus in an ISP network

Any of the individual data from 1 to 4 indicates a high communication quality when its value is small. Thus, it is necessary to control such that the individual values are less than predetermined criteria.

However, it is also considered that a total quantity of data which can be transmitted as one way or round trip in a certain period between the communication quality measuring apparatus and a target apparatus may be used as the communication quality data. In this case, the larger the value of the data becomes, the better the communication quality becomes.

In a preferred embodiment, the specifications of the method for measuring the communication quality data in the first communication quality measuring apparatus, and the specifications of the method for measuring the data in the second measuring apparatus are similar to each other. As a result, as in an example described later, it is possible to simply compare the magnitude of the individual data, and to add, subtract, and multiply the individual data. Thus, unified control becomes extremely simple in the control apparatus.

The case where the specifications of the method for measuring the communication quality data in the first communication quality measuring apparatus, and the specifications of the method for measuring the communication quality data in the second measuring apparatus are similar to each other includes the following cases.

1. Case where specifications of the individual methods for measuring a predetermined communication quality data are strictly identical: Even in this case, the individual measuring apparatuses are not necessarily the same products, and may be products different from one another which can use a method for measuring with the same specifications.

2. Case where specifications of the individual methods for measuring a predetermined communication quality data are different: In this case, it is necessary that the specifications of the individual methods for measuring are so similar that obtained communication quality data can be simply compared in a predetermined error range.

In addition, when the first ISP network and the second ISP network communicate through one or more independent intermediate ISP networks, a third communication quality measuring apparatus is provided in the individual intermediate ISP networks, and communication quality data measured by these apparatuses can be transmitted to the control apparatus. In this case, as described above, it is preferable that the specifications of the method for measuring in the third measuring apparatus are similar to the specifications of the individual measuring methods in the first measuring apparatus and the second measuring apparatus.

In addition, when the present invention is applied, specifications of a method for measuring communication quality data other than the communication quality data actually measured in the individual measuring apparatuses may not necessarily follow the same or similar specifications as long as they are not directly controlled by the control apparatus.

The present invention may be simultaneously applied to two or more types of communication quality data.

In a preferred embodiment, the communication path between the first communication apparatus and the second communication apparatus routes through an intermediate ISP network, the third communication quality measuring means is provided in the intermediate ISP network, and the third communication quality measuring means measures the communication quality data in the communication path, and transmits the data to the control means. The present invention is especially effective when the communication routes through an intermediate ISP network in this way.

In a preferred embodiment, the communication path between the first communication apparatus and the second communication apparatus are divided into multiple sections, and the communication quality data is measured in one direction and the other direction in the individual sections. In this case, especially in a preferred embodiment, the communication quality data is measured in one direction and the other direction for a section across a boundary between multiple adjacent networks.

In a preferred embodiment, the control means is provided with an output unit for instructing an output of an alarm when the individual communication quality data corresponding to individual sections do not satisfy first criteria. While the alarm may be shown on a screen of the display apparatus, it may be expressed as sound. The first criteria may be different in the individual sections.

In the present invention, as described above, both the communication quality data measured in the one direction, and the communication quality data measured in the other direction are obtained in the individual sections, and can be compared in the control apparatus. In general, the individual data obtained in the both directions in the individual sections must be approximately equal to each other. As a result, when the difference between them becomes large, since a problem possibly occurs in the communication quality in a section, an alarm output is instructed.

Also, when the communication quality data are measured in the multiple sections and are transmitted to the control apparatus, the communication quality data corresponding to a specific section may become absent due to failure in the measurement. In this case, it is preferable to instruct an output of an alarm indicating that the communication quality data for the specific section is missing in the control apparatus.

Further in a preferred embodiment, when the communication quality data in one direction for a specific section is absent in the control means, the communication quality data in the opposite direction for the specific section is predicted to be the communication data in the one direction. In addition, in general, since the individual data obtained in the both directions in the individual sections must approximately match one another, if the data obtained in the other direction is within a range of the first criterion, it is estimated that the possibility that the communication quality is normal in that section is high.

In this way, in the present invention, even when the communication quality data is missing in a certain section between multiple networks, it is possible to estimate whether the communication quality is maintained in that section. In the prior art, when a data is absent in a certain section inside a network, it is impossible to know whether abnormality occurs in that section. Consequently, when the data becomes absent, further recognition is not possible, and an action cannot be taken even if abnormality occurs in the communication quality inside the network.

In a preferred embodiment, the communication quality data is measured respectively at least in the specific section, an adjacent section adjacent to the specific section, and a combined section including the specific section and the adjacent section. Then, the control apparatus collects data from the individual sections, and controls them in a unified way. As a result, even when the communication quality data is missing in the specific section in the control means, the communication quality data in the combined section, and the communication quality data in the adjacent section can be obtained. The communication quality data in the specific section must reflect the communication quality data in the combined section, and the communication quality data in the adjacent section. Thus, based on these two types of measured data, it is possible to calculate the communication quality data in the specific section.

This calculation method differs depending on the type of the data. When the communication quality data is a data communication time in a certain form (such as packet round trip time, delay measured utilizing time-synchronizing feature, file transfer time, and one way trip time as described above), the difference between the communication quality data in the combined section, and the communication quality data in the adjacent section is estimated as the communication quality data in the specific section. When the communication quality data is the communication rate of a data, the data communication rate in the specific section is calculated from the communication rate and the distance of the combined section and the communication rate and the distance of the adjacent section according to a standard method.

In a preferred embodiment, the communication quality data is measured respectively at least in a specific section, an adjacent section adjacent to the specific section, and a combined section including the specific section and the adjacent section. As described above, when the communication state is normal in the entire combined section, the individual communication quality data in the specific section and the adjacent section must reflect the communication quality data in the combined section. Thus, the output of the alarm is instructed when a difference between a calculated value obtained by calculating from the communication quality data in the specific section and the communication quality data in the adjacent section, and the communication quality data in the combined section exceeds a third criterion.

This calculated value differs depending on the type of the data. When the communication quality data is the data communication time, the calculated value is an arithmetic sum of the communication quality data in the specific section and the communication quality data in the adjacent section, and this arithmetic sum must be approximately equal to the communication quality data in the combined section. Thus, the difference between this arithmetic sum and the communication quality data in the combined section exceeds the criterion, it can be determined that a certain communication failure or delay is present. When the communication quality data is the data communication rate, the data communication rate (estimated value) in the combined section is calculated from the communication rate and distance of the specific section and the communication rate and the distance of the adjacent section according to a standard method. This estimated value is compared with the communication rate actually measured in the combined section.

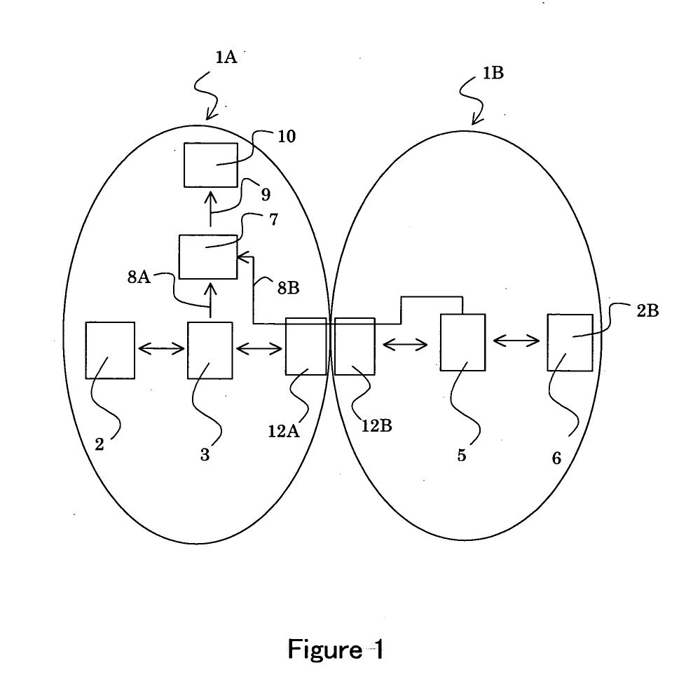

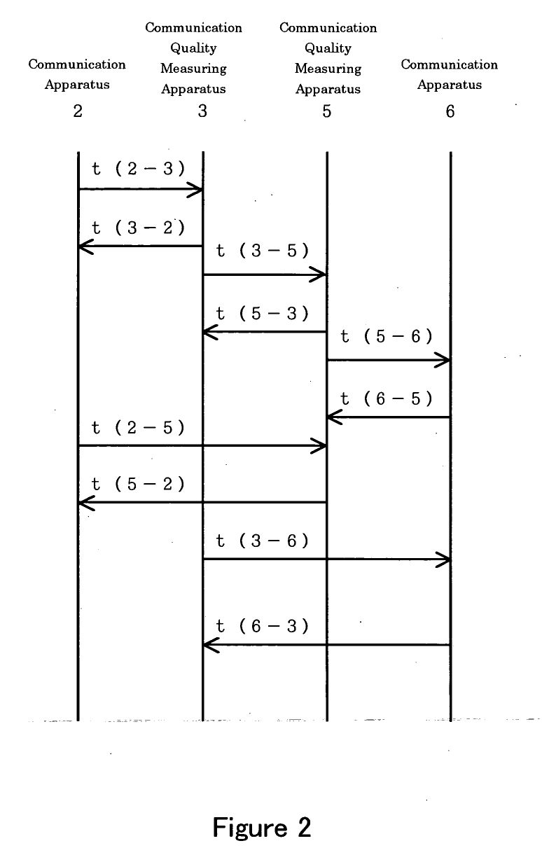

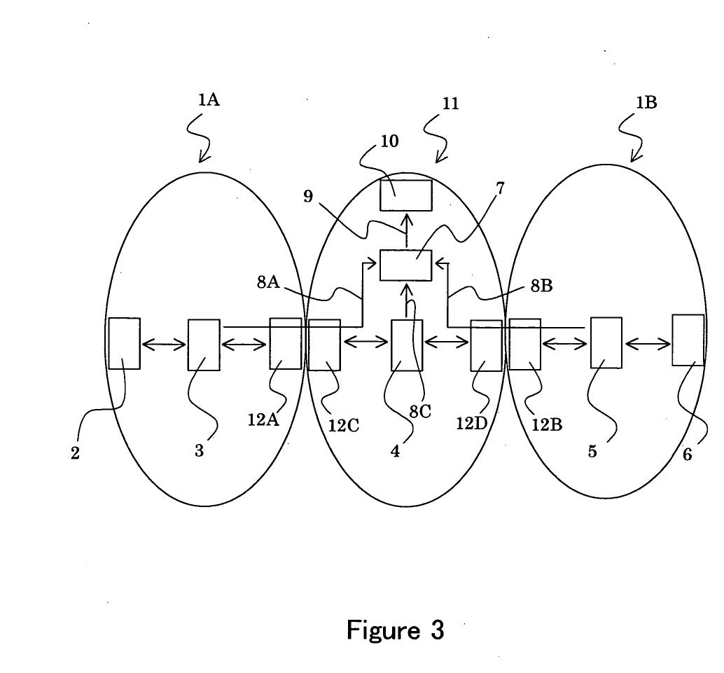

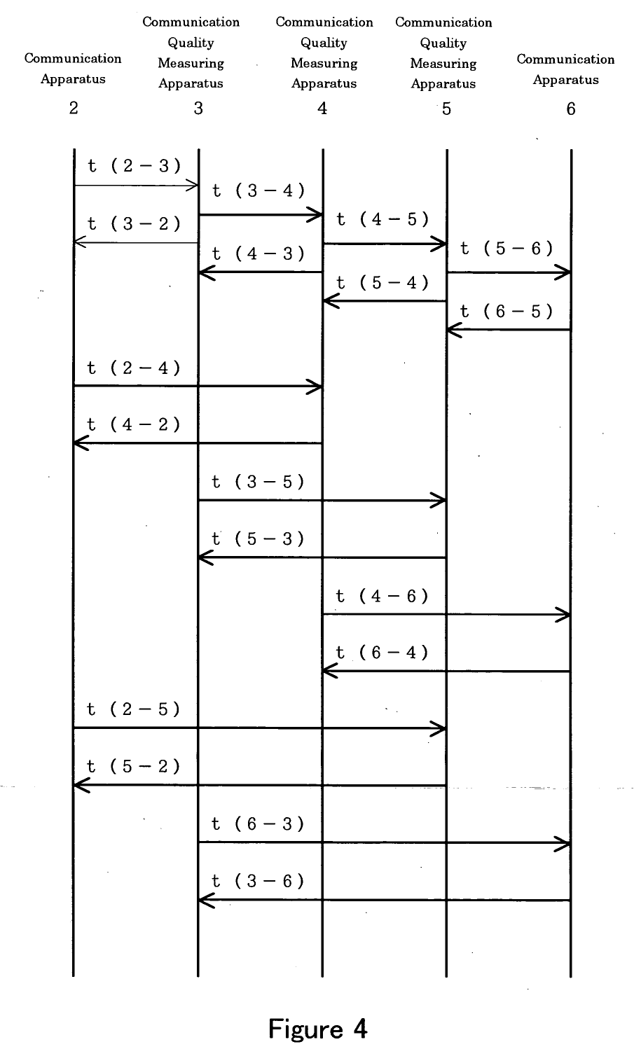

FIG. 1 is a block diagram schematically showing the constitution of a system according to an embodiment of the present invention, FIG. 2 is a chart showing relationships between individual communication apparatuses and individual communication quality measuring apparatuses in FIG. 1, and individual communication quality data, FIG. 3 is a block diagram schematically showing the constitution of a system according to another embodiment of the present invention, and FIG. 4 is a chart showing relationships between individual communication apparatuses and individual communication quality measuring apparatuses in FIG. 3, and individual communication quality data.

In the embodiment in FIG. 1, a communication apparatus 2, a communication quality measuring apparatus 3, an interface apparatus 12A, a control apparatus 7, and a display apparatus 10 are provided in an ISP network 1A, and a communication apparatus 6, a communication quality measuring apparatus 5, and an interface apparatus 12B are provided in an ISP network 1B. The apparatuses 3 and 5 and the interface apparatuses 12A and 12B are interposed in the communication path between the communication apparatuses 2 and 6.

In the system in FIG. 1, the individual communication quality data are measured while the measuring apparatuses 3 and 5 are set to a start point or an end point. Then, the apparatus 3 in the network 1A transmits measured data to the control apparatus 7 as an arrow 8A indicates. Measured data measured by the apparatus 5 in the network 1B is transmitted to the control apparatus 7 across a boundary between the networks 1B and 1A as an arrow 8B indicates.

FIG. 2 shows a list of data collected by the control apparatus 7. In this case, five sections subject to measurement 2-3, 2-5, 3-5, 3-6, and 5-6 exist. In FIG. 2, arrows directing to the right indicate one direction, and arrows directing to the left indicate the opposite direction (the other direction). A data measured in the one direction in the section 2-3 from the apparatus 2 to the apparatus 3 is indicated as t(2-3), and a data measured in the other direction in the section 2-3 is indicated as t(3-2). Other reference numbers are designated in the same way.

In an embodiment shown in FIG. 3, the communication apparatus 2, the communication quality measuring apparatus 3, and the interface apparatus 12A are disposed in the network 1A, the communication apparatus 6, the communication quality measuring apparatus 5, and the interface apparatus 12B are disposed in the network 1B, and a communication quality measuring apparatus 4, interface apparatuses 12C and 12D, the control apparatus 7, and the display apparatus 10 are disposed in the intermediate ISP network 11.

In the system in FIG. 3, individual communication quality data are measured while the measuring apparatuses 3, 4, and 5 are set to a start point or an end point. Then, data measured in the apparatus 3 in the network 1A is transmitted to the control apparatus 7 as an arrow 8A indicates, data measured in the apparatus 5 in the network 1B is transmitted to the control apparatus 7 as an arrow 8B indicates, and data measured in the apparatus 4 is transmitted to the control apparatus 7 as an arrow 8C indicates.

FIG. 4 shows a list of data collected by the control apparatus 7. In this case, nine sections subject to measurement 2-3, 2-4, 2-5, 3-4, 3-5, 3-6, 4-5, 4-6, and 5-6 exist. In FIG. 4, arrows directing to the right indicate one direction, and arrows directing to the left indicate the opposite direction (the other direction). A data measured in one direction in a section 2-3 from the apparatus 2 to the apparatus 3 is indicated as t(2-3), and a data measured in the other direction in a section 2-3 is indicated as t(3-2).

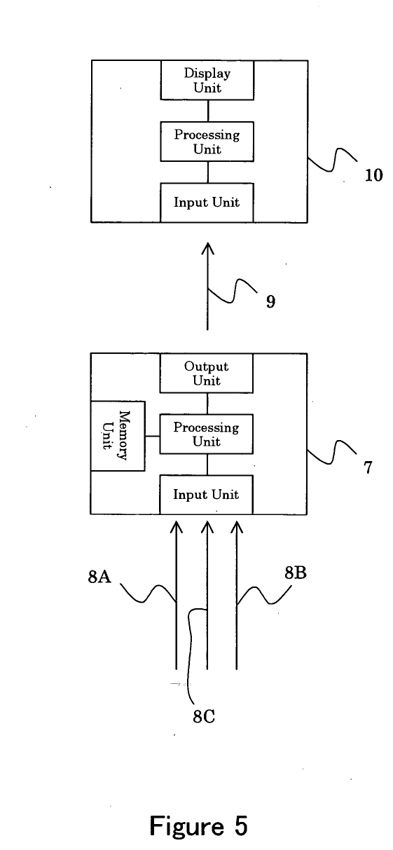

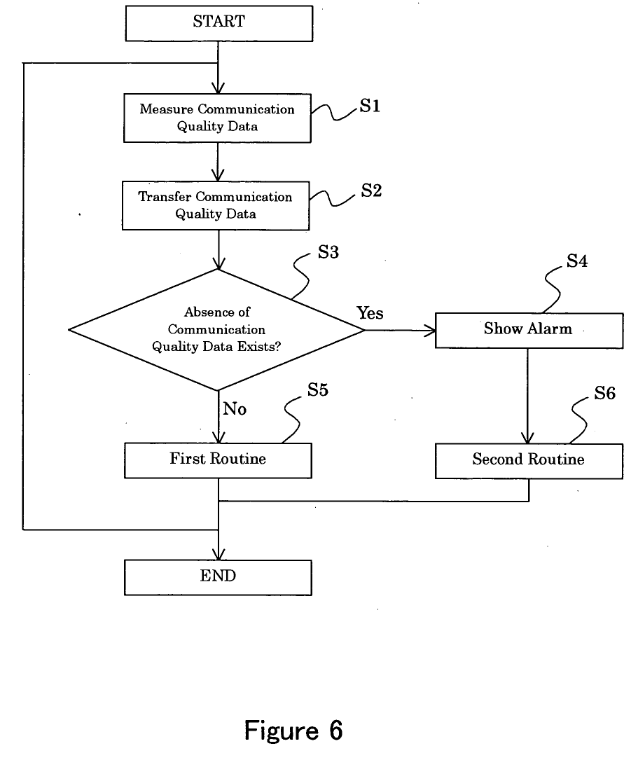

FIG. 5 is a block diagram schematically showing constitutions of a control apparatus and a display apparatus, and FIGS. 6 through 8 are typical flowcharts according to the present invention. The following section describes an example where the communication quality data is the data transmission time.

First, in the individual sections, the communication quality data are measured in both the one direction and the other direction (S1 in FIG. 6). Then, the individual measured data are transmitted to the control apparatus 7 as described above (S2). Then, in the control apparatus 7, the data actually transferred is checked against the types of data to be collected, and an existence of a missing data is checked (S3). When there is no missing data, the procedure enters a first routine (S5). If the data is partially missing, information instructing display of an alarm is transmitted from an output unit of the control apparatus to the display apparatus 10 as an arrow 9 indicates (S4), and then the procedure enters a second routine (S6).

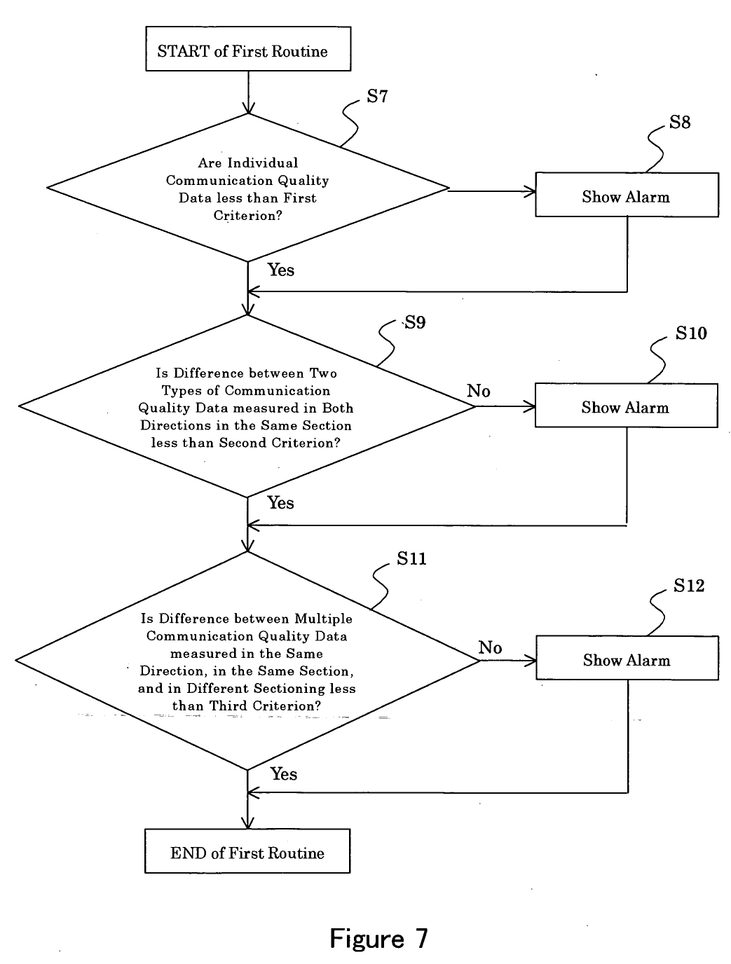

FIG. 7 shows the flow of the first routine. First, the individual communication quality data in the individual sections are compared with individual first criteria set for the individual sections, and it is checked if they are less than the first criterion (S7). If the communication quality data exceeds the first criterion in at least one section, an information instructing display of an alarm is output from the control apparatus, and is shown on the display apparatus (S8). If the communication quality data is less than the first criterion in all the sections, the procedure moves to Step S9.

In step S9, the difference between the communication quality data measured in the one direction and the communication quality data measured in the other direction within the same section is calculated, and this difference is compared with the second criterion. If this difference exceeds the second criterion, information instructing display of an alarm is output from the control apparatus, and is shown on the display apparatus (S10). If the communication quality data is less than the second criterion in all the sections, the procedure moves to Step S11.

In S11, a difference between multiple communication quality data measured for different sectioning in the same direction and in the same combined section, is calculated and is compared with the third criterion. For example, in FIG. 2, the section 2-5 and the section 3-6 are two types of such combined sections to be considered. Then, the combined section 2-5 is decomposed into, for example, the specific section 2-3 and the adjacent section 3-5, and the combined section 3-6 is partitioned into the specific section 3-5 and the adjacent section 5-6. Then, by adding the measured value t(2-3) in the one direction in the specific section 2-3 and the measured value t(3-5) in the adjacent section, an estimated value of the data for the combined section 2-5 must be obtained. Thus, if the difference between the arithmetic sum (t(2-3)+t(3-5)) and t(2-5) exceeds the criterion, it is estimated that a cause for the communication delay is present somewhere in the combined section 2-5. In the same way, if the difference between the arithmetic sum (t(3-5)+t(5-6)) and t(3-6) exceeds the criterion, it is estimated that a cause for the communication delay is present somewhere in the combined section 3-6.

Similarly, in the example in FIG. 4, combined sections to be considered include three types of the section 2-4, the section 3-5, and the section 4-6. A difference between an arithmetic=sum (t(2-3)+t(3-4)) and t(2-4), a difference between (t(3-4)+t(4-5)) and t(3-5), and a difference between (t(4-5)+t(5-6)) and t(4-6) are respectively compared with the predetermined third criterion.

While the description above is provided for the one direction, the same applies to the opposite direction (the other direction).

If the individual differences described above are less than the third criterion, the first routine terminates. When at least one of the individual differences described above exceeds the third criterion, information instruction display of an alarm is output (S12), and the first routine terminates.

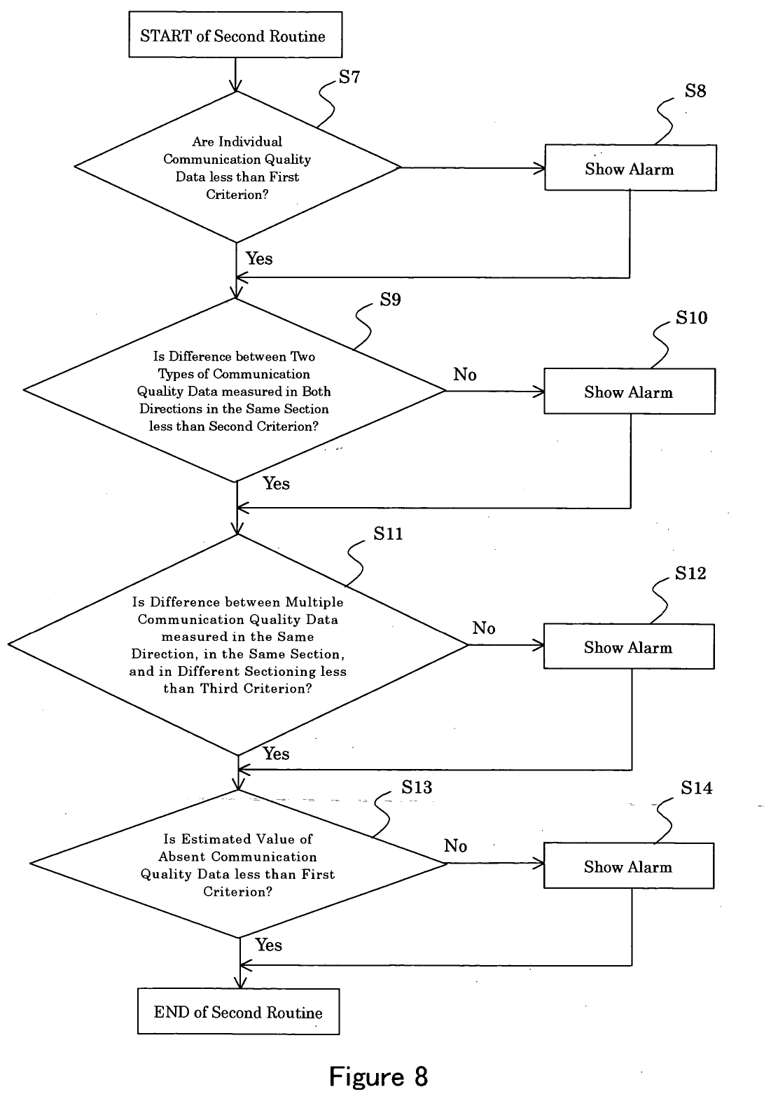

FIG. 8 shows the flow of the second routine. The second routine is a routine used for a case where an absence of the communication quality data is detected at least one section.

Since Step S7 through S12 are the same as those in the first routine shown in FIG. 7, description is not provided. In the second routine, after Steps S11 and S12 end, the communication quality data is estimated in the specific section where the data is absent, and the estimated value is compared with the predetermined first criterion (S13). Then, if the estimated value exceeds the first criterion, it is considered that the normal communication quality is not maintained in that specific section, information instructing display of an alarm is output (S14), and the second routine terminates. If the estimated value is less than the first criterion, the second routine terminates.

The communication quality data for the specific section absent of that data is estimated as described above.

As described above, in the control system according to the present embodiments, it is possible to calculate an estimated value of the communication quality data corresponding to a section where a data is missing by using one or both of the two estimation methods, and thus to estimate a communication error or communication barrier at a high probability in the specific section based on this estimated value, resulting in taking a quick action.

As described above, with the present invention, the quality of the communication between a first communication apparatus existing in a first ISP network and a second communication apparatus existing in a second ISP network is controlled above a certain level in the unified way.

1. A communication quality control system for controlling quality of communication between a first communication apparatus existing in a first ISP network and a second communication apparatus existing in a second ISP network; the system comprising:
a control means for collecting and controlling communication quality data measured by a first communication quality measuring apparatus in said first ISP network for at least a part of a communication path between said first communication apparatus and said second communication apparatus, and communication quality data measured by a second communication quality measuring apparatus in said second ISP network for at least a part of the communication path.

2. The system according to claim 1, characterized in that specifications of how to measure said communication quality data in said first communication quality measuring apparatus, and specifications of how to measure said communication quality data in said second communication quality measuring apparatus are equivalent to each other.

3. The system according to claim 1 or 2, characterized in that said communication path is divided into multiple sections, and said communication quality data is measured both in one direction and the other direction for the individual sections.

4. The system according to claim 3, characterized in that said control means comprises an output unit which instructs an output of an alarm when said communication quality data corresponding to said individual sections does not satisfy a first criterion.

5. The system according to claim 3 or 4, characterized in that said control means comprises an output unit which instructs an output of an alarm when a difference between said communication quality data measured in said one direction and said communication quality data measured in said other direction does not satisfy a second criterion for said individual sections.

6. The system according to any one of claims 3 to 5, characterized in that said control means comprises an output unit which instructs an output of an alarm when said communication quality data corresponding to a specific section is missing.

7. The system according to any one of claims 3 to 6, characterized in that said communication quality data in said other direction corresponding to a specific section is used as estimation of said communication quality data in said one direction in the specific section in said control means when the communication quality data in the one direction in the specific section is missing.

8. The system according to any one of claims 3 to 7, characterized in that the system is constituted such that said communication quality data are collected respectively at least from a specific section, an adjacent section adjacent to the specific section, and a combined section including the specific section and the adjacent section to said control apparatus, and an estimated value for the communication quality data in the specific section is calculated based on the communication quality data in the combined section and the communication quality data in the adjacent section in the control means when the communication quality data in the specific section is missing.

9. The system according to any one of claims 3 to 8, characterized in that the system is constituted such that said communication quality data are collected respectively at least from a specific section, an adjacent section adjacent to the specific section, and a combined section including the specific section and the adjacent section to said control apparatus, and an output unit is provided for the control apparatus which instructs an output of an alarm when a difference between a calculated value obtained by calculating from the communication quality data in the specific section and the communication quality data in the adjacent section, and the communication quality data corresponding to the combined section exceeds a third criterion.

10. The system according to any one of claims 1 to 9, characterized in that said communication path between said first communication apparatus and said second communication apparatus routes to an intermediate ISP network, a third communication quality measuring apparatus is disposed in the intermediate ISP network, and communication quality data in the communication path is measured by the third communication quality measuring apparatus and then, is transmitted to said control means.

11. A communication quality control method for controlling quality of communication between a first communication apparatus existing in a first ISP network and a second communication apparatus existing in a second ISP network; the method comprising:
a control step for collecting and controlling communication quality data measured by a first communication quality measuring apparatus in said first ISP network for at least a part of a communication path between said first communication apparatus and said second communication apparatus, and communication quality data measured by a second communication quality measuring apparatus in said second ISP network for at least a part of the communication path.

12. The method according to claim 11, characterized in that specifications of how to measure said communication quality data in said first communication quality measuring apparatus, and specifications of how to measure said communication quality data in said second communication quality measuring apparatus are equivalent to each other.

13. The method according to claim 11 or 12, characterized in that said communication path is divided into multiple sections, and said communication quality data is measured both in one direction and the other direction for the individual sections.

14. The method according to claim 13, characterized in that said control step comprises an output step for instructing an output of an alarm when said communication quality data corresponding to said individual sections does not satisfy a first criterion.

15. The method according to claim 13 or 14, characterized in that said control step comprises an output step for instructing an output of an alarm when a difference between said communication quality data measured in said one direction and said communication quality data measured in said other direction does not satisfy a second criterion for said individual sections.

16. The method according to any one of claims 13 to 15, characterized in that said control step comprises an output step for instructing an output of an alarm when said communication quality data corresponding to a specific section is missing.

17. The method according to any one of claims 13 to 16, characterized in that said communication quality data in said other direction corresponding to a specific section is used as estimation of said communication quality data in said one direction in the specific section in said control step when the communication quality data in the one-direction in the specific section is missing.

18. The method according to any one of claims 13 to 17, characterized in that the method is constituted such that said communication quality data are collected respectively at least from a specific section, an adjacent section adjacent to the specific section, and a combined section including the specific section and the adjacent section to said control step, and an estimated value for the communication quality data in the specific section is calculated based on the communication quality data in the combined section and the communication quality data in the adjacent section in the control step when the communication quality data in the specific section is missing.

19. The method according to any one of claims 13 to 18, characterized in that the method is constituted such that said communication quality data are collected respectively at least from a specific section, an adjacent section adjacent to the specific section, and a combined section including the specific section and the adjacent section to said control step, and that the control step comprises an output step for instructing an output of an alarm when a difference between a calculated value obtained by calculating from the communication quality data in the specific section and the communication quality data in the adjacent section, and the communication quality data corresponding to the combined section exceeds a third criterion.

20. The method according to any one of claims 11 to 19, characterized in that said communication path between said first communication apparatus and said second communication apparatus routes to an intermediate ISP network, a third communication quality measuring apparatus is disposed in the intermediate ISP network, and communication quality data in the communication path is measured by the third communication quality measuring apparatus and then, is transmitted to said control step.

21. A program of instructions for execution by the computer to perform a communication quality control process for controlling quality of communication between a first communication apparatus existing in a first ISP network and a second communication apparatus existing in a second ISP network; the process comprising:
a collecting step for collecting into a control unit communication quality data measured by a first communication quality measuring apparatus in said first ISP network for at least a part of a communication path between said first communication apparatus and said second communication apparatus, and communication quality data measured by a second communication quality measuring apparatus in said second ISP network for at least a part of the communication path.

22. A computer-readable medium having the program according to claim 21.
